(19) United States
(12) Patent Application Publication
(10) Pub. No.: US 2004/0163663 A1
(43) Pub. Date: Aug. 26, 2004

(54) Lipstick breath freshener dispensers

(76) Inventor: Gary Cooper, East Hampton, NY (US)

Correspondence Address: ALFRED M. WALKER, 225 OLD COUNTRY ROAD, MELVILLE, NY, 11747-2712, US

(21) Appl. No.: 10/786,535

(22) Filed: Feb. 25, 2004

Related U.S. Application Data
(60) Provisional application No. 60/450,387, filed on Feb. 26, 2003.

(51) Int. Cl. B67D 5/64

(52) U.S. Cl. 132/297

(57) ABSTRACT

A combination lipstick and breath freshener barrel dispenser accommodates both lipstick and breath fresheners therein. A single tubular lipstick dispenser includes a hollow cap housing closing the lipstick barrel, wherein the cap separately dispenses breath freshener therefrom, such as mint tablets or dissolvable wafer film strips. The dispenser may include a miniature version of pump spray or aerosol propelled breath spray with integral dispensing cap, or a flexible liquid dispenser which attaches to the end of a standard lipstick cover. Alternatively, the cap may be a further cap upon the lipstick barrel cap, and may alternatively dispense a cosmetic cake block, such as lip gloss or lip balm therefrom.

### RELATED APPLICATIONS

This application is based in part upon provisional patent application serial No. 60/450,387, filed Feb. 26, 2003, and claims benefit under 35 USC 119(e) therefrom.

### FIELD OF THE INVENTION

The present invention relates to a combination lipstick and breath freshener barrel accommodating both lipstick and breath fresheners therein.

### BACKGROUND OF THE INVENTION

There are five distinctly different breath freshener types and/or dispensers in common use. The first type is breath mints as exemplified by TIC-TAC® lime mints distributed by Ferraro U.S.A. Inc. of Somerset, N.J. Another type is non-aerosol breath freshener spray with a pump dispenser as represented by SWEET BREATH® from Health Tech, Inc. of Totowa, N.J. A similar product using an aerosol dispenser is BINACA® peppermint breath spray as distributed by Playtex Products, Inc. of Dover, Del. Another type is breath drops, in a liquid such as SWEET BREATH® peppermint drops also distributed by Health Tech. Another type of breath freshener is a paper-thin strip, which dissolves on the tongue. One popular type is LISTERINE® POCKETPAKS™ as distributed by Warner-Lambert Consumer Healthcare of Morris Plains, N.J.

Among related patents include U.S. Pat. No. 5,499,747 of Quennessen, dated Mar. 19, 1996, which describes a tubular breath freshener which uses a tubular lipstick-type barrel as a template prototype configured carrier structure to accommodate a vial of dispensable breath freshener therein. However, Quennessen '747 does not suggest or describe dispensing both lipstick and breath freshener from a single, capped barrel.

In addition, U.S. Patent Publication No. 2002/0162355 A1 of Andersen, dated Nov. 7, 2002, describes a fashion bracelet which includes a shallow make-up compact-shaped carrier, which is mounted upon a bracelet strap, for storing two separate tubular objects therein, such as a lipstick barrel and a breath freshener dispenser. But Andersen '355 does not suggest or describe a single tubular lipstick dispenser, which includes a cap separately dispensing breath freshener therefrom.

### OBJECTS OF THE INVENTION

It is therefore an object of the present invention to provide a single tubular lipstick dispenser which includes a cap closing the lipstick barrel, wherein the cap separately dispenses breath freshener therefrom.

It is also an object of the present invention to provide a lipstick dispenser with a cap, wherein the cap separately dispenses cosmetic cake blocks, such as lip gloss, lip balm or lip protector medications, such as CHAPSTICK®, therefrom.

### SUMMARY OF THE INVENTION

In keeping with the aforementioned objects and others, which may become apparent, the present invention integrates an example of each type of breath freshener with a lipstick dispenser for convenient use.

Several embodiments are described in this invention. The first embodiment uses a modified lipstick cover cap, which is longer than the normal type to create a compartment for the housing and easy dispensing of breath freshener tablets, such as breath mints. Eight to twelve breath mints, or more depending upon the size of the breath mints and the storage capacity of the compartment, can be conveniently carried this way.

Another embodiment is similar to the function of the first type, but it is an accessory compartment that is attached by friction fit to a standard lipstick cover.

Yet another embodiment of this invention uses either an elongated lipstick cap or an attachable accessory to create a compartment for receiving a miniature version of pump spray or aerosol propelled breath spray with integral dispensing cap.

Another embodiment of this invention is configured as a squeezable flexible liquid dispenser which attaches to the end of a standard lipstick cover. By pulling it off the lipstick cap, unscrewing the cap, and squeezing the body of the dispenser, a drop or two of liquid breath freshener is dispensed onto the user's tongue.

Additionally, the most compact breath freshener dispenser embodiment is for dispensing breath freshener wafer film strips which are either stored in a stacked configuration within the dispenser, or which are stored in an annular space created around the periphery of a standard lipstick cap.

Finally, instead of dispensing various breath fresheners, the cap dispenser can dispense cosmetic cake blocks, such as lip gloss, lip balm or lip medications, such as CHAPSTICK®, therefrom.

### BRIEF DESCRIPTION OF THE DRAWINGS

The present invention can best be understood in connection with the accompanying drawings, in which:

FIG. 1 is a perspective view of a breath freshener dispenser of this invention housed in an elongated lipstick cover cap;

FIG. 2 is a side crossectional view of the breath freshener dispenser of FIG. 1 showing breath mints within;

FIG. 3 is a top view of the dispenser of FIGS. 1 and 2 showing the method of operation of the dispenser cover;

FIG. 4 is a perspective view of an alternate embodiment of breath mint dispenser configured as an accessory compartment that attaches to a standard lipstick cap;

FIG. 5 is a side elevation of a lipstick dispenser for breath sprays which attaches to the cover cap of a lipstick;

FIG. 6 is a side elevation of a lipstick dispenser for liquid breath drops which attaches to the cover cap of a lipstick;

FIG. 7 is a perspective view of an alternate embodiment which is used to house breath strips in an annular space around a standard lipstick cap;

FIG. 8 is a side crossectional view of the breath freshener dispenser of FIG. 7;

FIG. 9 is a top view with cap removed of the dispenser for breath strips shown in FIG. 7;

FIG. 10 is a side elevation of a preferred embodiment for attaching a spray type breath freshener to a lipstick;

FIG. 11 is a perspective view of an alternate embodiment for a cap dispenser which is retrofitted over a lipstick barrel;

FIG. 12 is an exploded view thereof;

FIG. 13 is a close up perspective view of the cap dispenser;

FIGS. 14 and 15 are crossectional side views of alternate embodiments for cap dispensers for breath freshener tablets and wafer films respectively;

FIG. 16 is a partial crossectional side view of an alternate embodiment for a cap dispenser having a cosmetic cake block therein, with a height adjustment washer therein;

FIG. 17 is a partial crossectional side view thereof, further illustrating manual raising of the cosmetic cake block;

FIG. 18 is a top plan view thereof, further illustrating the manual raising of the cosmetic cake block;

FIG. 19 is a perspective diagrammatic view in partial crossection of the height adjustment washer and its relation to the cap dispenser interior;

FIG. 20 is an enlarged close-up top plan view of the guide keying of the height adjustment washer, preventing rotation thereof;

FIG. 21 is an enlarged diagrammatic close up view, shown in partial crossection, depicting the protruding attachment of a further slidable height adjustment member, engageable with the cosmetic cake block of FIGS. 16 and 17; and,

FIG. 22 is an exterior elevational view of the sliding means of the further height adjustment member as in FIG. 21.

### DETAILED DESCRIPTION OF THE INVENTION

The following embodiments are meant to be illustrative of the present invention, which make disclose further embodiments, known to those skilled in the art, in connection with the novel features as described herein.

For example, breath freshener dispenser 20 shown in FIG. 1 is integrated with standard lipstick 25 with actuator ring 23. It is housed in elongated lipstick cover/cap 21 with access cap 22.

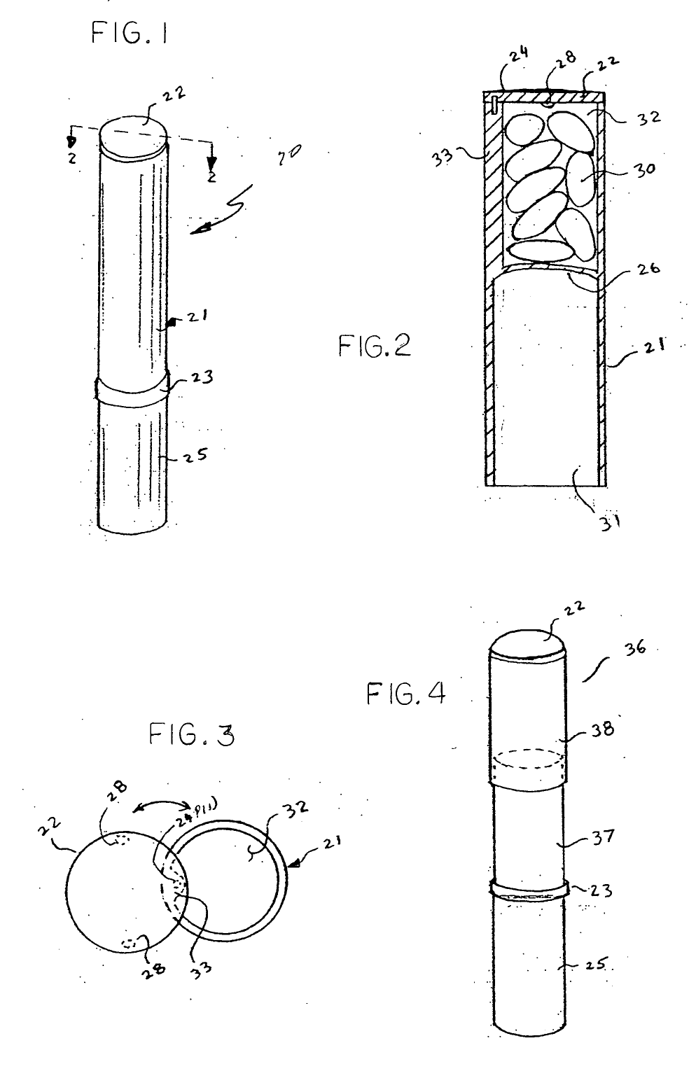

FIG. 2 shows breath mints 30, such as TIC TAC® tablets, housed in upper compartment 32, with cap 22 and wall 26 that isolates the lipstick compartment from the mint 30 compartment.

As shown in FIG. 3, cover 22 is attached to wall ridge 33 via pin 24 which permits cover 22 to rotate with respect to cap 21. Cover 22 has one or more nibs 28 which protrude slightly downward to engage the inner wall of compartment 32 to lock in a closed position. By pushing sideways on cover 22 to overcome resistance from each nib 28, it can be opened a small amount to conveniently discharge a single breath mint, or it can be swung open, as in FIG. 3, to permit easy replenishment of breath mints from a purchased container.

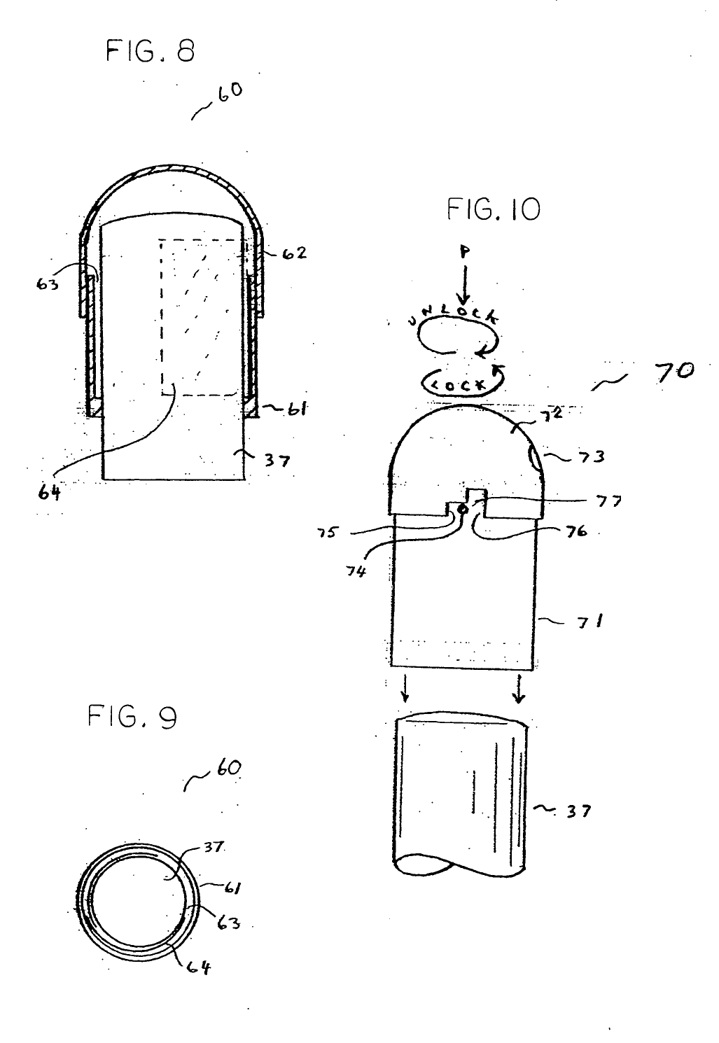

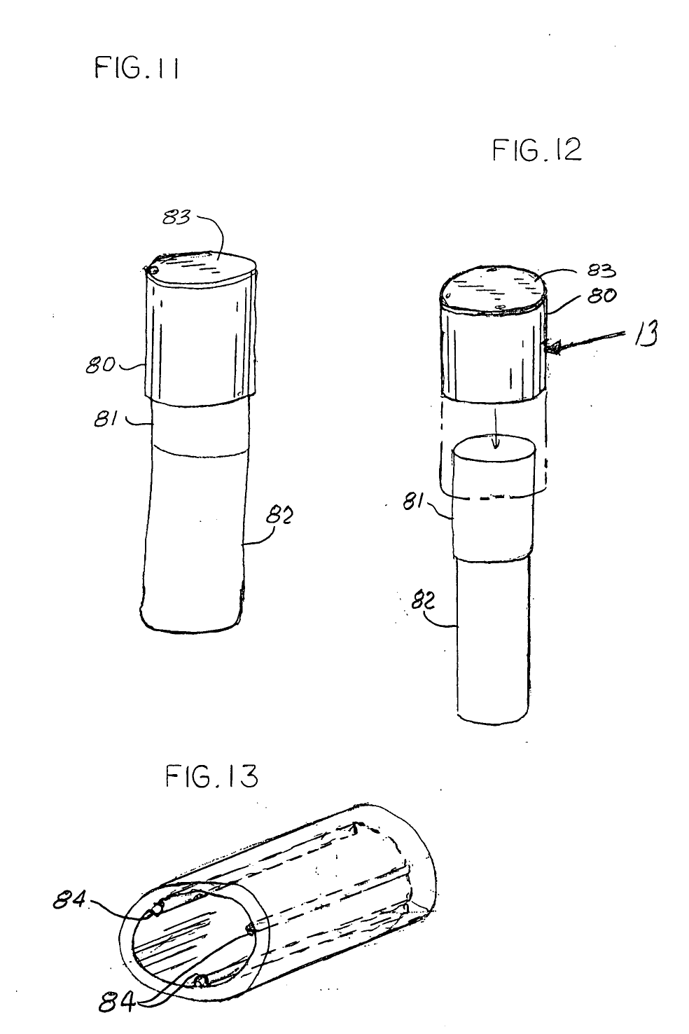

Other openable covers may be applicable to cover dispenser 21, as hinged covers (not shown), or friction fit covers, such as shown in FIG. 11-13, wherein cap dispenser 80 fits by friction fit upon lipstick barrel cap 81, or as shown in FIG. 8 herein, wherein cover cap 62 fits upon housing 61.

An alternate embodiment 36 shown in FIG. 4 implements the breath mint dispenser as an accessory that attaches to standard lipstick cover/cap 37 via a friction fit of housing 38 over cap 37. This can be aided by a well known technique using molded axial ridges on the internal coupling recess (not shown) of housing 38.

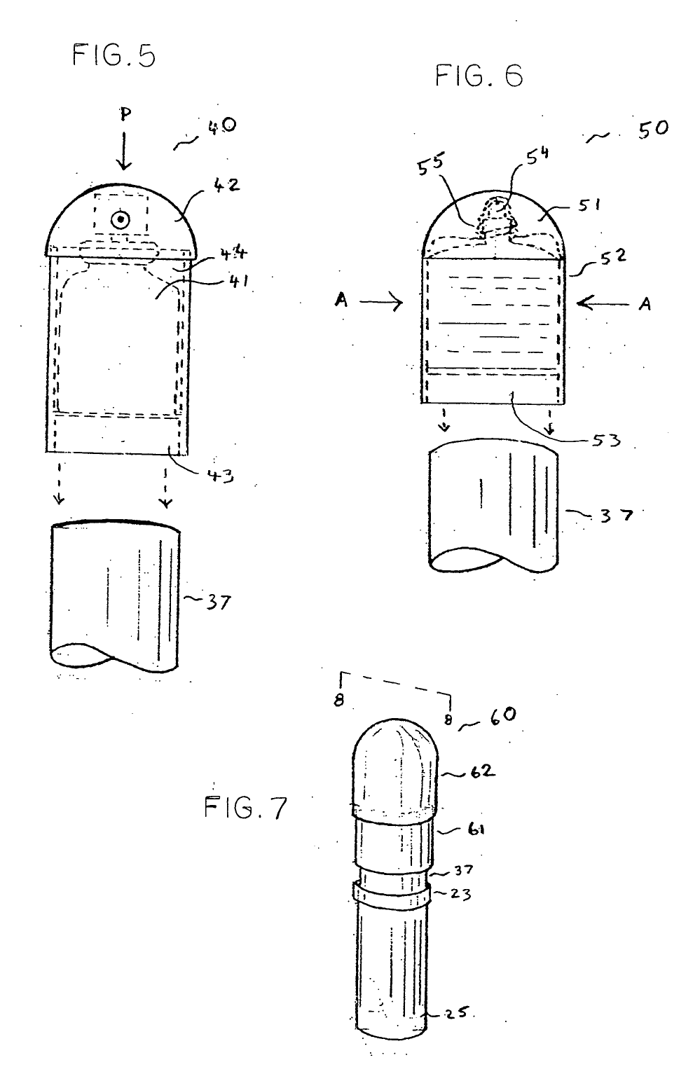

FIG. 5 shown another embodiment of breath freshener dispenser 40 which will accommodate either a pump spray or aerosol spray breath spray insert 41. Although illustrated as an accessory which attaches by friction fit (at recess 43) to standard lipstick cap 37, dispenser 40 can be integrated into an elongated lipstick cover/cap similar to item 21 in FIG. 1. Compartment 44 has internal ribs (not shown) which grasp insert 41 by friction fit. Insert 41 is a shortened version of the commercially available type of container for non-aerosol or aerosol (pressurized) breath liquid. Dome cap 42 is attached to the discharge valve/nozzle such that a force P exerted on cap 42 will discharge breath freshener through the discharge orifice shown on the side of cap 42. When depleted, a full insert 41 is substituted for the depleted one. Cap 42 can either be an integral part of the disposable insert 41, or it can attach to the nozzle by force fit and thereby be transferred from insert to insert.

FIG. 6 shows yet another embodiment of breath freshener attached to a lipstick. This one dispenses breath drops which are highly concentrated as compared to breath sprays.

Therefore, as shown in FIG. 6, dispenser 50 can be somewhat shorter than spray embodiment 40 since less volume is required. Dispenser 50 is designed to be attached by friction fit to the end of a standard cover/cap 37. For ergonomic reasons, it is not desirable to integrate dispenser 50 with an elongated cover/cap since it is more convenient to disassociate dispenser 50 (at recess 53) from lipstick cover 37 prior to use. Also, housing 52 should be molded of resilient material such that it can be easily squeezed at points A to discharge one or two drops onto the user's tongue. Cap 51 screws onto nozzle extension 54 at threads 55. The operation for use is simply to pull off dispenser 50 from cap 37, unscrew cap 51, and squeeze.

FIG. 7 shows a dispenser 60 of breath strips attached to standard lipstick cover/cap 37. Since the volume of each breath strip is negligible, it is not surprising that this embodiment is most compact. This dispenser minimally increases the length of the lipstick and barely increases its diameter beyond operating ring 23.

Breath strips 64 (as in FIGS. 8 and 9) are easily wrapped around the outer periphery of cap 37 and stored in annular space 63 formed by housing 61 which attaches to cover 37 via a friction fit ring at its base. Since they extend above the upper edge of housing 61, they can be easily inserted and retrieved from recess 63 when cap 62 is removed. A typical breath wafer strip 64 is tissue paper thin and measures about 0.8″ by 1.2″ (21 by 31 mm). Since it is wrapped around cap 37 lengthwise, it would fit as shown in FIG. 8. Strips 64 can be easily transferred from a purchased container to recess 63 for replenishing.

Alternatively, breath wafer strips can be stacked within a cap dispenser, as shown in FIG. 15 herein.

In two additional embodiments of lipstick dispensers for spray type breath fresheners, two different approaches to preventing possible accidental discharge in purse or pocket are described. The first embodiment involves the removal of the discharge orifice from cap 42 as shown in FIG. 5. Cap 42 is then redesigned into an overcap (same outer shape otherwise) for a discharge nozzle which is integral with insert 41. Cap 42 will then have a friction fit on the outer surface of the housing of dispenser 40. Modified cap 42, in this embodiment, would be removed to gain access to the nozzle atop insert 41.

FIG. 10 shows a preferred alternate embodiment, which retains discharge through cap 72 at orifice 73. Cap 72 is integral with insert 41 within. Housing 71 has one or more pegs 74 (one shown) protruding from opposite sides. These engage one or more stepped cutouts 77 on the sides of cap 72. By rotating cap 72 slightly clockwise such that pegs 74 touch limit stop wall 75, cap 72 is prevented from moving when force P is applied. This is the lock position for storage. By rotating cap 72 slightly counterclockwise so that pegs 74 touch “unlocked” limit wall 76, cap 72 is free to move downward relative to housing 71 thereby discharging a spray of breath freshener from insert container 41 within.

FIGS. 11 and 12 show a further embodiment for a cap dispenser 80 which can be retrofitted over an existing lipstick barrel cap 81 of an existing cylindrical lipstick barrel 82. Cap dispenser 80 can be opened at a top thereof by any means, however, preferably slidable top 83 is used, similar to slidable top 22 of FIG. 3 herein. As shown in FIG. 13, cap dispenser 80 preferably has interior friction fit members 84 for fixation upon existing lipstick barrel cap 81. Although other friction fit means may be applied, such as a texturized interior wall, in FIG. 13, there is shown three equidistant, longitudinally extending liquid applied rubber or other elastomeric ribs 84.

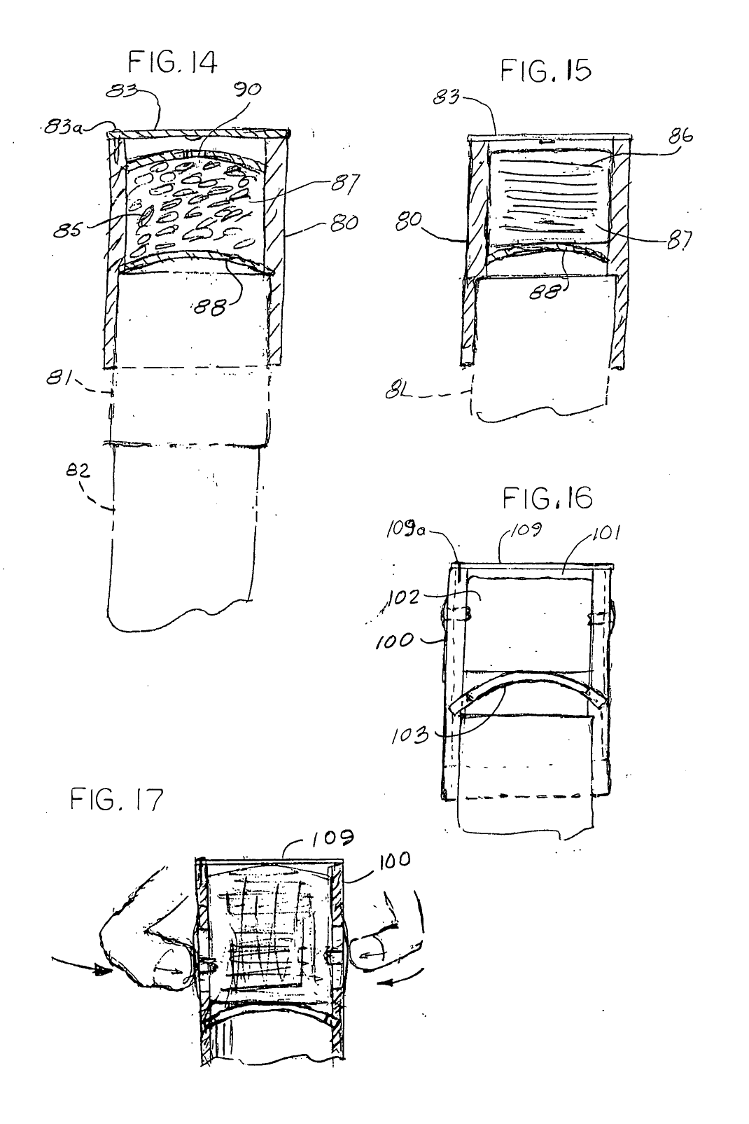

As shown in FIGS. 14 and 15 a hollow recess 87 includes storage of breath freshener tablets 85 (as in FIG. 14) or breath freshener wafer films 86 (as in FIG. 15). A preferably arcuate bottom wall 88 supports the breath freshener tablets or wafer films within recess 87. Optional top arcuate wall 89 may be provided for the breath freshener tablets, with an orifice 90 for dispensing a limited number of tablets therethrough. While bottom wall 88 is shown arcuate, it may be flat or bear any other geometric configuration.

FIGS. 16-22 show a further alternate embodiment, where cap dispenser 100 includes hollow recess 101 for supporting a cosmetic cake block type of material block 102, such as lip gloss, lip balm or lip medication. While a convention twist windup mechanism (not shown) may be provided for advancing the declining cosmetic cake block 102 upward to expose the remaining material for application upon the lips of the user, a further embodiment includes an upwardly advancing bottom wall 103 supporting cosmetic cake block 102 within hollow recess 101.

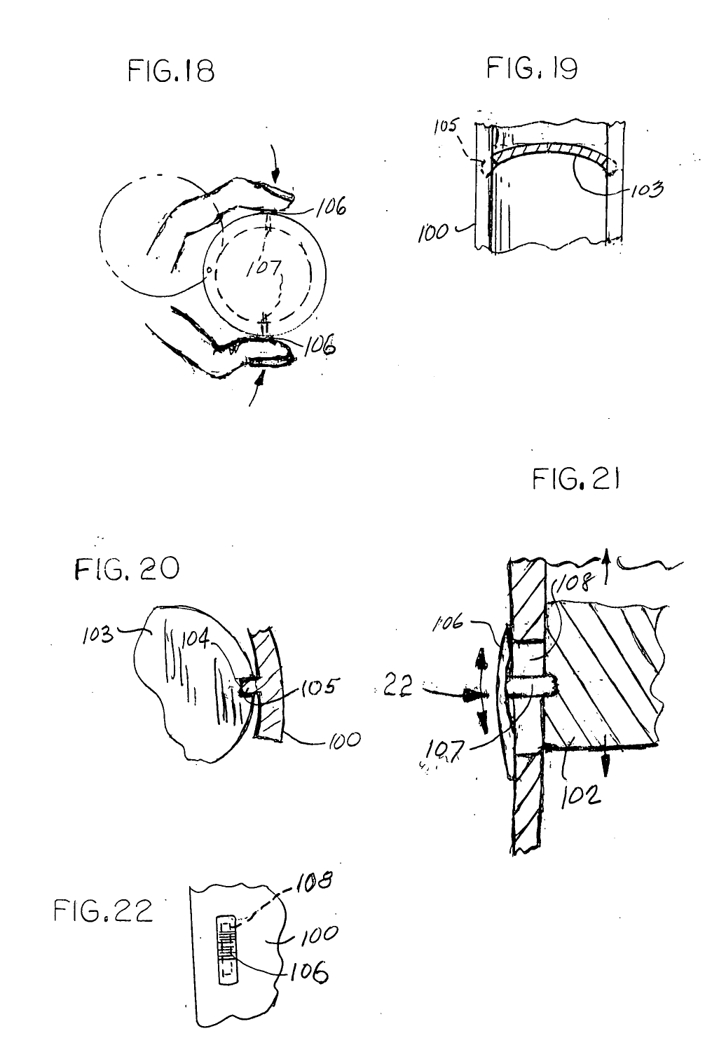

The cosmetic cake block 102 is advanced upward since bottom wall 103 is a flexible disk washer with opposite grooves 104 engaging longitudinally extending ribs 105 extending longitudinally within cap dispenser 100, as shown in FIGS. 19-20.

An alternate adjustment mechanism is also shown in FIGS. 16-22, where handles 106 protrude therethrough a recess 101 into cosmetic cake block 102 by projections 107, which are manually moved by external finger engagable handles 106 through slot 108.

While top 83 can have other configurations, such as being hinged (not shown), FIGS. 16-22 show horizontally slidable cap 109, which pivots about pin 109a.

It is further noted that other modifications known to those skilled in the art may be made to the present invention, without departing from the scope of the invention, as described herein.

I claim:

1. A combination lipstick and breath freshener dispenser barrel accommodating both lipstick and breath fresheners therein, comprising:
a lipstick dispenser including a lipstick barrel cap closing the lipstick barrel, wherein said cap separately dispenses breath freshener therefrom.

2. The dispenser as in claim 1 wherein said lipstick cover cap includes a hollow dispenser compartment for dispensing of said breath freshener therefrom.

3. The dispenser as in claim 2 wherein said dispenser compartment is integrated with a standard lipstick cover cap, said dispenser compartment having a further cover cap alternately opening and closing said dispenser compartment, said dispenser compartment separated from said lipstick dispenser by a wall therebetween.

4. The dispenser as in claim 3 wherein said dispenser compartment stores a miniature breath freshener aerosol spray dispenser.

5. The dispenser as in claim 3 wherein said dispenser compartment stores a miniature breath freshener pump spray dispenser.

6. The dispenser as in claim 3 wherein said compartment includes a squeezable flexible liquid dispenser dispensing liquid breath freshener onto the user's tongue.

7. The dispenser as in claim 3 wherein said dispenser compartment dispenses breath mint tablets, housed in said dispenser compartment.

8. The dispenser as in claim 3 wherein said dispenser compartment dispenses dissolvable flexible breath mint wafer film strips, housed in said dispenser compartment.

9. The dispenser as in claim 8 wherein said breath freshener wafer film strips are stacked within said dispenser compartment.

10. The dispenser as in claim 8 wherein said breath freshener wafer film strips are stored wrapped around a peripheral edge of a portion of said lipstick barrel cap.

11. The dispenser as in claim 2 wherein said further cover cap is slidably operable, said further cover cap being attached to a wall ridge via a pin which permits said further cover cap to rotate with respect to said dispensing compartment protruding downward to engage an inner wall of said dispenser compartment, to lock in a closed position.

12. The dispenser as in claim 11 wherein said further cover cap includes at least one nib.

13. The dispenser as in claim 3 wherein said cover cap of said dispenser compartment attaches to standard lipstick cover cap via a friction fit over said lipstick barrel cap.

14. The dispenser as in claim 6 wherein a dome cap is attached to a discharge valve/nozzle such that a force is exerted on side dome cap, discharging breath freshener from an insert container through a discharge orifice, wherein when said breath freshener is depleted from said insert container, a full insert container is substituted for said depleted insert container.

15. The dispenser as in claim 2 wherein said cover cap includes a stop restraint preventing accidental discharge of said breath fresheners therefrom.

16. The dispenser as in claim 15 wherein said stop restraint includes said cover cap having at least one stepped cutout engagable with at least one protruding peg protruding from said dispenser compartment, said at least one peg engaging said stepped cutout on at least one side of said cover cap, wherein, said cover cap is rotatable such that said at least one peg touches a limit stop wall, preventing said cover cap from moving when force is applied thereto.

17. A combination lipstick barrel and cosmetic cake block dispenser, said lipstick barrel having a cap, said cap having a dispenser dispensing a cosmetic cake block therefrom.

18. The dispenser as in claim 17 wherein said cap dispenser has a hollow compartment supporting said cosmetic cake block therein.

19. The dispenser as in claim 18 wherein said cap dispenser includes an advancement mechanism for advancing upward a remaining unused portion of said cosmetic cake block for application upon the lips of the user.

20. The dispenser as in claim 19 wherein said advancement mechanism includes a manually movable flexible disk washer movable axially upward within said cap dispenser.
